(19) United States
(12) Patent Application Publication
(10) Pub. No.: US 2014/0085316 A1
(43) Pub. Date: Mar. 27, 2014

(54) FOLLOW ME NOTIFICATION AND WIDGETS

(71) Applicant: AVAYA INC., Basking Ridge, NJ (US)

(72) Inventor: Srinivasan Narayanan, Pune (IN)

(73) Assignee: AVAYA INC., Basking Ridge, NJ (US)

(21) Appl. No.: 13/626,319

(22) Filed: Sep. 25, 2012

(51) Int. Cl. G06T 1/00

(52) U.S. Cl. 345/501

(57) ABSTRACT

Methods and systems for providing a virtual reality environment are disclosed. The environment includes shared information that is presented by a user interface to all of the participants to a meeting held within the virtual reality environment. In addition, information that is personal to particular participants can be displayed by the user interface to those participants. Accordingly, the user interface provides shared information and personal information areas. In addition, a user can interact with both the shared and personal information areas, without needing to leave the virtual reality environment.

### FIELD

Methods and systems for providing dynamic visual notification of shared and personal communications and information in a virtual environment are described.

### BACKGROUND

Meetings can be a very important part of doing business. With good planning, participation, and follow-up, meetings can help move a project or decision forward or bring people to consensus. One of the benefits to having people in one place is the ability to read body language. Various types of media attempt to address this when face to face meetings aren't possible. For example, enterprises can use videoconferencing to simulate face to face communications, without losing all of the possible non-verbal clues. Virtual reality environments are evolving to be able to mimic natural movement and non-verbal physical clues and sentiment. In today's multi-modal enterprise, a variety of meeting types are used for effective communication. In each type of meeting, the most successful participation will come from people who are actively engaged in the meeting.

Most virtual reality environment meetings do not incorporate most or all of the access a person might have in a real meeting. The better engaged that the conference participants are, the better the chance for success of the meeting. Some tools have been created to make the virtual reality environment meeting rooms useful. For example, white boards or screens can play videos, display documents, and provide other types of visual output. However, the virtual reality environment meetings have not made available access to a person's communications or applications privately within the virtual reality environment. Accordingly, having to toggle between a virtual reality environment meeting and desktop applications does not keep a meeting participant actively engaged throughout the meeting, especially if he or she is expecting something important to come in, like an email from a boss.

### SUMMARY

Methods and systems for providing dynamic visual notifications or presentations of shared and personal communications and information in a virtual environment are provided. More particularly, a virtual reality environment (VRE) that presents shared information to all participants or users in the VRE, as well as information that is personal to individual users, is provided. The information that is personal to a user is displayed as a private wall to only the user to whom the information pertains. The private wall displays content dynamically from several sources, without the user having to refresh the private wall. As a result, individual meeting participants can then react to any real-time issues presented by their personal information, while participating in the meeting comprising the shared information. Moreover, by presenting the personal information within the VRE from a variety of sources, a participant can monitor all of his or her personal communications or other private information, while participating in the meeting hosted in the VRE, and without requiring that the user leave the VRE in order to access such personal information. If the participant moves through the VRE from room to room, the participant's personal information travels with him or her, making participation in meetings hosted in the VRE easy and efficient.

In accordance with at least some embodiments of the present disclosure, a system that provides a virtual reality environment for meetings between multiple users is provided. The system includes a virtual reality server that executes a virtual reality (VR) module or application. The VRE can present shared information that is made available to all participants in the meeting through communication devices that are interconnected to the virtual reality server, either directly or through one or more networks. In addition, embodiments of the present disclosure can present information to an individual user that is personal to that user within the VRE. Accordingly, users can monitor personal information, such as email, voice mail, text messages, calendar information, personal data, or the like, from within the VRE, while participating in a meeting or other shared event also presented within the VRE.

Methods in accordance with embodiments of the present disclosure include providing a virtual reality module through a central service, such as through a server accessible via a network. Users register with the virtual reality module in order to participate in the VRE. The VRE can present shared information to the participants of a meeting or other participatory event. For example, the VRE can present the participants of a meeting as avatars that interact with one another and/or other objects within the VRE. The VRE can additionally support the communication of audible information, such as the speech of individual participants, text, shared documents or presentations, or the like. Embodiments of the present disclosure present information that is personal to individual participants to those participants, within the VRE. For example, information that is part of the meeting generally can be presented within a shared information area of a communication device display, while information that is personal to the user of a communication device can be presented within a personal information area of the communication device display.

Additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting components of a system in accordance with embodiments of the present disclosure;

FIG. 2A is a block diagram depicting components of a virtual reality server in accordance with embodiments of the present disclosure;

FIG. 2B is a block diagram depicting components of a communication device in accordance with embodiments of the present disclosure;

FIG. 3A depicts a virtual reality user interface in accordance with embodiments of the present disclosure;

FIG. 3B depicts a virtual realty user interface in accordance with other embodiments of the present disclosure;

FIG. 3C depicts a virtual realty user interface in accordance with other embodiments of the present disclosure; and

FIG. 4 is a flowchart depicting aspects of a method in accordance with embodiments of the present disclosure.

### DETAILED DESCRIPTION

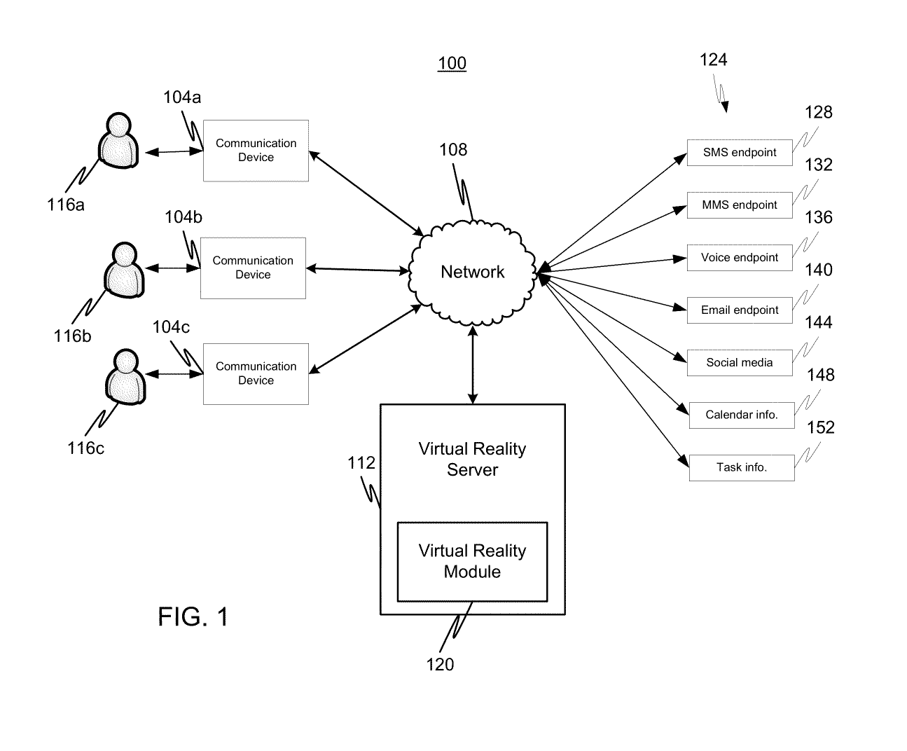

FIG. 1 is a block diagram depicting components of a communication system 100 in accordance with embodiments of the present disclosure. In general, the system 100 includes a plurality of communication devices 104 interconnected by one or more networks 108 to a virtual reality server 112. In general, the virtual reality server 112 operates to present a virtual reality environment to users 116 associated with the communication devices 104.

Each communication device 104 generally supports communications with one or more other communication devices 104, either directly or in connection with a virtual reality environment. As described herein, the virtual reality environment can include shared information provided as part of a shared environment. In addition, embodiments of the present disclosure provide a virtual reality environment that can present information specific to one or more communication devices 104 and/or associated users 116. In an exemplary embodiment, a communication endpoint 104 is capable of providing visual information depicting a virtual reality environment to a user 116. Accordingly, examples of communication devices 104 include desktop computers, laptop computers, tablet computers, thin client devices, smart phones, and the like.

The communication network 108 may be any type of network that supports communications using any of a variety of protocols. For example, but without limitation, a network 108 may be a local area network (LAN), such as an Ethernet network, a wide area network (WAN), a virtual network such as but not limited to a virtual private network (VPN), the Internet, an intranet, an extranet, a public switched telephone network (PSTN), a wireless network such as but not limited to a cellular telephony network or a network operating under any one of the IEEE 602.11 suite of protocols, the Bluetooth protocol or any wireless protocol. Moreover, the network 108 can include a number of networks of different types and/or utilizing different protocols. Accordingly, the network 108 can be any network or system operable to allow communications or exchanges of data between communication devices 104 directly, via the virtual reality server 112, and/or a communication or other server or network node.

The virtual reality server 112 generally operates to provide a virtual reality environment to communication devices 104, such that users 116 of the communication devices 104 can interact through the virtual reality environment. Moreover, the virtual reality server 112 disclosed herein can operate to support communications or the delivery of other information that is specific or personal to individual communication devices 104 and/or users 116 through the presented virtual reality environment. Accordingly, the virtual reality server 112 can comprise or be provided as part of a communication server. In connection with providing a virtual reality environment, the virtual reality server 112 can implement or provide a virtual reality environment module (also referred to herein as virtual reality module or simply as VR module) 120. In general, the virtual reality module 120 operates to present the virtual reality environment to users 116 through communication devices 104 participating in a virtual reality environment. Moreover, the virtual reality environment is controlled by the virtual reality module 120 with respect to each communication device 104 participating in a virtual reality session. Through a connection between the VR module 120 on the VR server 112 and the communication device 104, shared virtual reality information is presented to all users 116 participating in the virtual reality session. In addition, the VR module 120 presents individual users 116 with information that is personal to such individuals. Accordingly, the virtual reality module 120 can provide both general and user specific information to users 116 of selected communication devices 104.

In addition, the system 100 can include various information sources or message endpoints 124. The information sources 124 may comprise endpoints that engage in communications with a communication device 104 participating in a virtual reality meeting or other event hosted by the virtual reality server 112. Moreover, an information source 124 may be associated with an endpoint comprising a communication device 104 participating in a VRE hosted by the virtual reality server 112. Examples of information sources 124 include short message service (SMS) 128, multimedia messaging service (MMS) 132, voice telephony 136, email 140, and social media 144 endpoints or sources. Other examples include calendar information 148 and tasks or other reminders 152. In general, the information sources 124 can further be associated with services. The system 100 may expose standard application programming interfaces (APIs) that can be used by information sources interacting with the VRE. Moreover, messages or other information provided by an information source 124 directed to a communication device 104 associated with a user 116 participating in a VRE hosted by the virtual reality module 120 is routed through the virtual reality module 120, for display as part of information that is personal to a user 116, via the network 108, as described in greater detail elsewhere herein.

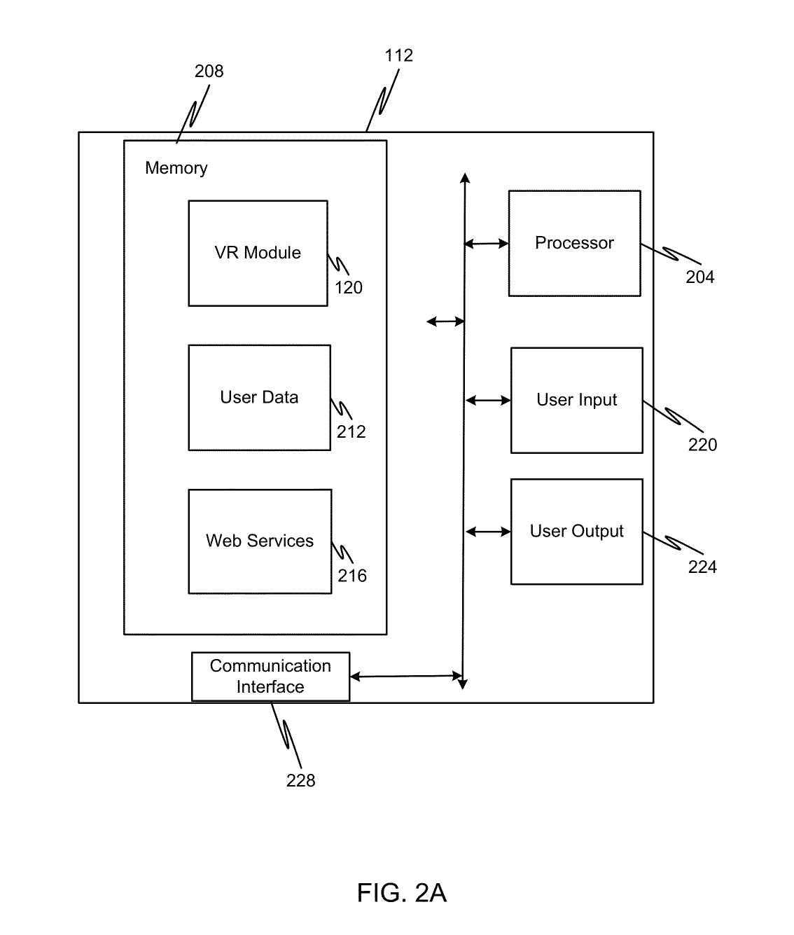

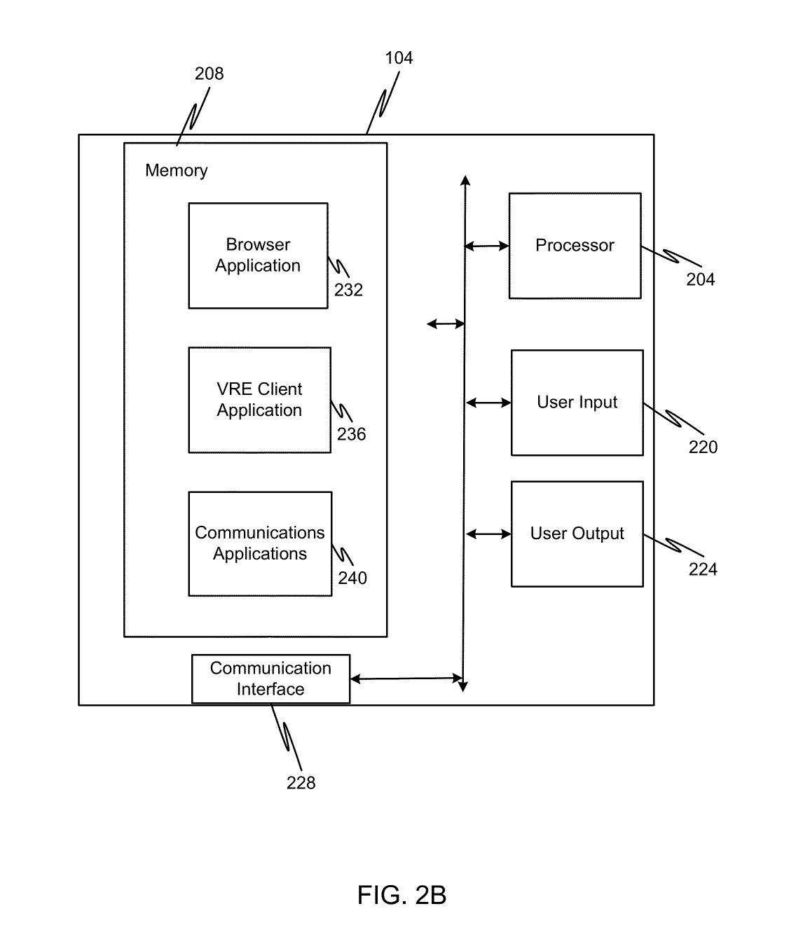

FIGS. 2A and 2B are block diagrams depicting components of a virtual reality server 112 and of a communication device 104 respectively in accordance with embodiments of the present disclosure. The virtual reality server 112 and the communication device 104 each can include a processor 204 capable of executing program instructions. The processor 204 can include any general purpose programmable processor or controller for executing application programming. Alternatively, the processor 204 may comprise a specially configured application specific integrated circuit (ASIC). The processor 204 generally functions to run programming code implementing various functions performed by the associated server or device. For example, the processor 204 of the VR server 112 can implement functions performed in connection with the presentation of a virtual reality environment to users 116 of communication devices 104 through execution of a virtual reality environment module 120. The processor of a communication device 104 can operate to present shared and personal information to a user 116 through execution of a browser application 232 or a VRE client application 236.

The virtual reality server 112 and the communication device 104 additionally include memory 208. The memory 208 can be used in connection with the execution of programming by the processor 204, and for the temporary or long term storage of data and/or program instructions. For example, the virtual reality server 112 memory 208 can include an application implementing the virtual reality environment module 120, stored user data 212, and a web services module 216 that can operate in connection with the VR module 120 to present shared and personal information to communication devices 104 participating in a VRE. The memory 208 of a communication device 104 can include a browser application 232 a VRE client application 236, and various communication applications 240. The memory of a server 112 or device 104 can include solid state memory that is resident, removable and/or remote in nature, such as DRAM and SDRAM. Moreover, the memory 208 can include a plurality of discrete components of different types and/or a plurality of logical partitions. In accordance with still other embodiments, the memory 208 comprises a non-transitory computer readable storage medium. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read.

The VR server 112 and a communication device 104 can also include or be associated with user input devices 220 and user output devices 224. Such devices 220 and 224 can be used in connection with the provisioning and operation of a VRE, and/or to allow users to control operations of the VRE and the display of and interaction with shared and personal information. Examples of user input devices 220 include a keyboard, a numeric keypad, a touch screen, a microphone, scanner, and pointing device combined with a screen or other position encoder. Examples of user output devices 224 include a display, a touch screen display, a speaker, and a printer. The VR server 112 and a communication device 104 also generally include a communication interface 228 to interconnect the associated server 112 or device 104 to a network 108.

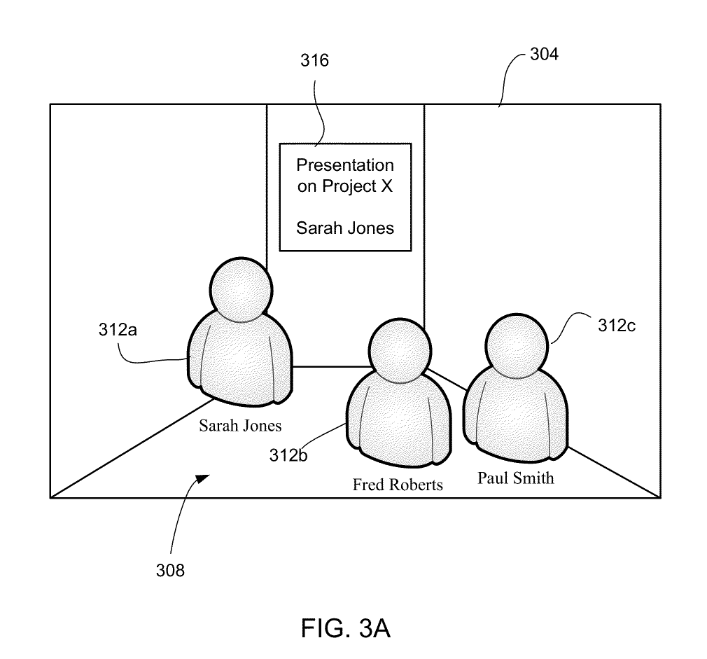

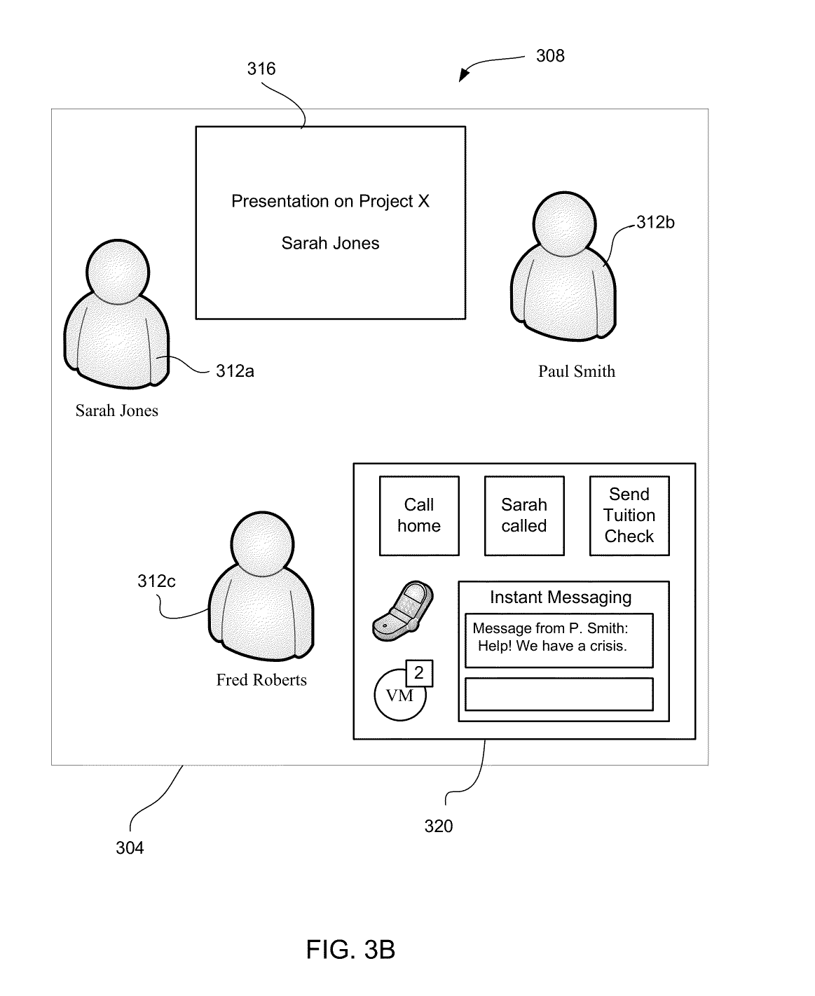

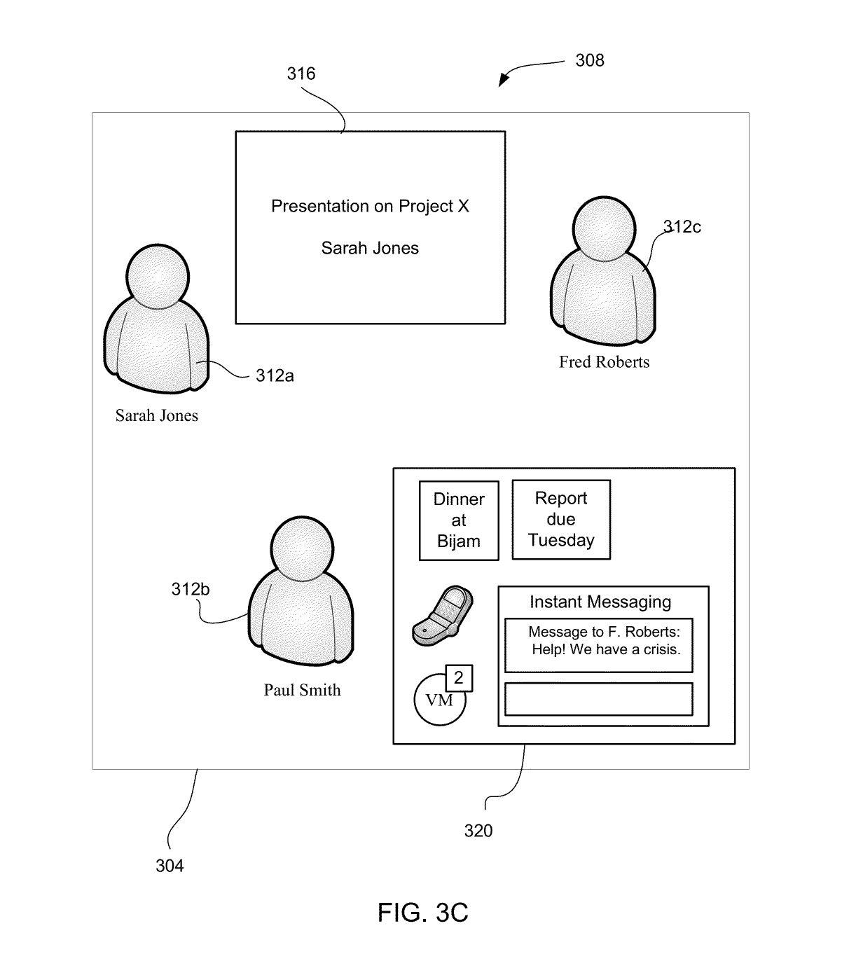

FIGS. 3A-3C depict views of a user interface 304 in accordance with embodiments of the present disclosure. The user interface 304 can be provided by or in connection with a user output device 224 (e.g., a display) of a communication device 104. The user interface 304 can be generated through or in connection with the operation of the VR module 120 running on the VR server 112, and/or in connection with a companion application, such as a browser application 232 and/or a VRE client application 236, running on the communication device 104.

More particularly, the view of the user interface 304 in FIG. 3A shows a presentation of a conventional VRE display including only shared information 308 generated by the VR module 120. In this VRE display, users 116 of communication devices 104 participating in a VR meeting are depicted as avatars 312. In addition to depicting the presence of the users 116 through avatars 312, shared information 308 can include VRE objects 316. VRE objects 316 presented as part of shared information 308 are available to all of the participating users 116. In this example, a VRE object 316 in the form of a presentation is included in the shared information 308. Other examples of VRE objects 316 that can be presented as part of shared information 308 include documents, figures, videos, audible information, text, etc. The presentation of only shared information 308 to a participating user 116 may be the result of a selection 116 by that user, for example where the user is giving the presentation, or to otherwise avoid distractions. Accordingly, the first user 116a Sarah Jones, who is giving the presentation included in the shared information 308, might chose to receive only shared information 308 through the user interface 304.

In accordance with embodiments of the present disclosure, a user interface 304 can also present information that is personal to one or more users 116 to those users 116. Examples of user interfaces 304 generated by the VR module 120 that present both shared information 308 and information that is personal to a user 320 are depicted in FIGS. 3B and 3C. The information that is personal to a user 320 can include personal communications, personal calendar entries, and personal task entries. Moreover, the personal information can be generated through one or more communications modes, APIs, channels, or facilities that are in communication with the VR module 120, such as but not limited to email, voice messaging, calendar information, reminders, tasks, instant messaging, text messaging, and the like. An ability to share personal communications within a certain vicinity can be controlled by the user. In an exemplary embodiment, a sphere or circle may be presented as a space where a second user may be invited to view the private information of a first user in a shared area. The shared area could be a collaborative session where the first user could give the second user permission to use any personal communications or applications on the private wall.

FIG. 3B is an example of a user interface 304 that presents both shared information 308 and information that is personal to the second user 116b, Fred Roberts. The user interface 304 in this example is presented by the communication device 104b associated with Fred Roberts. Moreover, the particular collection of information included in this user interface 304 can be unique to Fred Roberts. Accordingly, the reminders 324, voice mail message 328, and instant message information depicted as part of the information specific to an individual user 320 is not displayed to other users 116, unless an item of information specific to an individual user 320 is shared among participants. For example, an instant messaging session between Fred Roberts and Paul Smith, another participant in the VR meeting comprising the shared information 308, is depicted. Accordingly, the information that is personal to a user 320 can include out of band communications between a participant in a VR meeting and other participants, or between a participant in a VR meeting and entities that are not participating in the VR meeting. The information can be a collection of one-way notifications, or some or all of the information may be in a two-way interactive format. In addition, the information that is personal to a user can include calendar events or other reminders. The format of the collection of notifications can be modified to the preferences of the user. The format might be in the form of, but is not limited to, a personal pod, a personalized wall, a display area, a visual representation of a tablet, a visual representation of a note, or other visual representation common to certain applications or services.

With reference now to FIG. 3C, an example of a user interface 304 that includes shared information 308 and information that is personal 320 to the third user 116c, Paul Smith, is depicted. The user interface 304 in this example is presented by the communication device 104c associated with Paul Smith. The information included in this user interface 304 can be unique to Paul Smith. In this example, Paul Smith is the originator of an instant message to Fred Roberts. Accordingly, the information that is personal 320 to Paul Smith includes the content of the instant message that is also depicted as part of the information that is personal to Fred Roberts. If the user moves to another VR meeting in the VRE, the information that is personal to the user 320 moves with the user. In this example, if Fred Roberts moves to a second VR meeting, he can still see the instant message from Paul Smith as well as his notes and voicemail tile.

In accordance with embodiments of the present disclosure, the user interface 304 therefore allows participants in a VR meeting or other event hosted within a VRE by a VR module 120 to access personal communications and information within the VRE, independent of his or her location in the VRE. Accordingly, a user 116 can monitor shared 308 and personal 320 information through a common user interface 304.

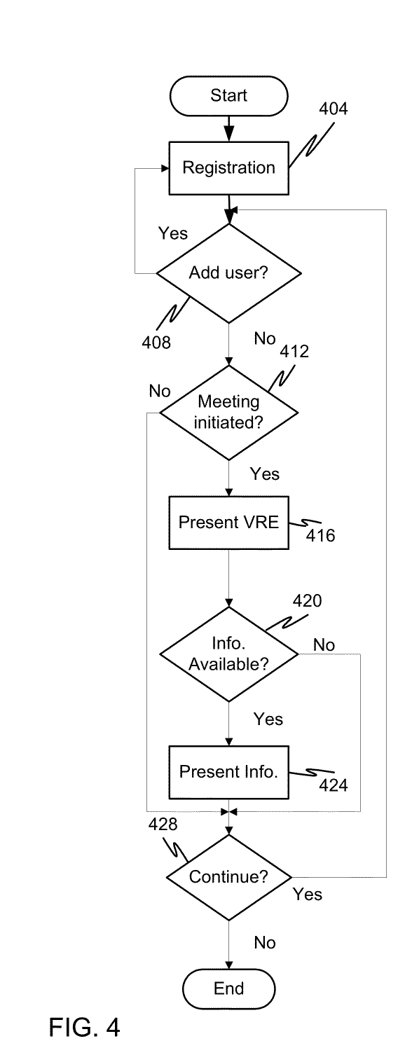

With reference now to FIG. 4, aspects of a method for providing shared information and information that is personal to a user through a VRE are depicted. Generally, the method begins with a registration step (step 404). During registration a user 116 registers with a VR system or module 120. Registration can include providing address or other identifying information for the registering user 116 to the VR module 120 that enables the VR module 120 to present information specific to a registered user to that user 116 through a VRE. Examples of identifying information that can be provided includes an email address, short message system number, instant message address, phone number, or the like. Information provided during registration can also include information that enables the VR module 120 to access electronic calendar, reminder, or task information for the user 116. If required, a user 116 can also include password information to enable access by the VR module 120 to information sources associated with the user. At step 408, a determination can be made as to whether additional users 116 remain to be registered. If additional users 116 remain to be registered, the process can return to step 404, and information for the next registering user 116 can be collected.

At step 412, a determination can be made as to whether a meeting within the VRE provided through the VR module 120 has been initiated. Initiation of a meeting can include at least a first user 116 operating a communication device 104 to interconnect to the VR server 116 and to provide information requesting the creation of a VRE. The request can be for a meeting that will be initiated at the time the request for creation of the VRE is made, or for a meeting that will be held some time in the future. Initiation of a meeting can also include providing the VR module 120 with a list of invitees. The VR module 120 can provide functions that include conventional conference call functions, such as initiating calls or other contacts to invitees, and/or receiving calls or contacts and authentication information from meeting participants, and joining participants to the VRE.

Once a meeting is initiated, users 116 who have registered with the VR system and who have initiated or joined a meeting are presented with the VRE generated for that meeting by the VR module 120 (step 416). More particularly, a user interface 304 presenting the VRE can be provided by a display associated with or included as part of the participating user's communication device 104. The meeting is generally depicted within the shared information area 308 as a shared space that is attended by avatars 312 representing the users 116 who are currently participating in the meeting. In addition, any shared information or other VRE objects 316 can be depicted in the shared information area 308. The shared information area 308 can be updated as users 116 join or leave the meeting, and/or as VRE objects 316 are added, changed, or removed.

At step 420, a determination can be made as to whether information that is personal to a user 116 participating in the VRE environment presented for the meeting is available. For example, through a registration process, the VR module 120 may be provided with alerts whenever information, such as an incoming email, text message, or other communication is available for a user 116. As another example, calendar information, reminders, or other personal information can be presented by the VR module 120 as part of the VRE. If such information is available for a user 116, it is presented through the user interface 304 of the communication device 104 for the user within the area for information that is personal to a user 320 (step 424). In accordance with at least some embodiments of the present disclosure, the personal information area 320 for the user can be updated as new or updated information is received. In addition, a user 116 can respond to communications or otherwise interact with the personal information 320 through the user interface 304 presented by the VR module 120.

A determination can be made as to whether the presentation of the VRE is to continue (step 428). If operation is to continue, the process can return to step 412. Alternatively, the process can end. In accordance with at least some embodiments, a VRE can be maintained indefinitely. Accordingly, a VRE can serve as a “commons” in which registered users 116 can interact with other registered users 116 to exchange information. Whether provided as part of a particular meeting for a limited period of time, or as a commons, embodiments of the present disclosure allow a user 116 to maintain an awareness of personal communications, calendars, reminders or other information, through the VRE. Accordingly, a user can better focus on shared information 308, even while monitoring personal communication channels.

As can be appreciated by one of skill in the art after consideration of the present disclosure, the provision of a user interface 304 that presents both shared information 308 and personal information 320 to a participating user can assist the user 116 in engaging with a VRE meeting, by removing the need or temptation for the user 116 to leave the VRE in order to check personal information or engage in private communications. Therefore, by providing support for accessing personal information and engaging in personal communications, a VRE provided by a VR module as disclosed herein can lead to more productive VRE meetings, and/or to more satisfied users 116.

A VR module 120 that simultaneously provides shared 308 and personal 320 information to a user through a user interface 304 is possible. For example, a VRE environment can be provided as a hosted service on behalf of an ad hoc collection of users 116. As another example, a VRE can implement a private meeting room on behalf of a selected set of users 116. Moreover, a VRE provided by a VR module 120 as disclosed herein can be provided as an on demand service, or as an enterprise facility that is made available to employees and/or customers of the enterprise.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for presenting information in a virtual reality environment, comprising:
providing a virtual reality module;
registering a first user with the virtual reality module;
registering a second user with the virtual reality module;
using the virtual reality module, providing the first and second users with shared information;
using the virtual reality module, providing the first user with information that is personal to the first user, wherein the information that is personal to the first user is not provided to the second user.

2. The method of claim 1, wherein the information that is personal to the first user originated from a source outside of the virtual reality environment.

3. The method of claim 2, further comprising:
using the virtual reality module, providing the second user with information that is personal to the second user, wherein the information that is personal to the second user is not provided to the first user; and
providing the shared information and the information that is personal to the first user from the virtual reality module to a first communication device.

4. The method of claim 3, further comprising:
presenting the shared information in a shared information area of a display of the first communication device;
presenting the information that is personal to the first user in a personal information area of the first communication device.

5. The method of claim 4, further comprising:
providing the shared information and the information that is personal to the second user from the virtual reality module to a second communication device;
presenting the shared information in a shared information area of a display of the second communication device;
presenting the information that is personal to the second user in a personal information area of the second communication device.

6. The method of claim 1, wherein registering the first user with the virtual reality module includes providing authentication credentials for the first user to the virtual reality module.

7. The method of claim 6, wherein registering the first user with the virtual reality module further includes obtaining at least a first communication address associated with the first user, wherein at least some of the information that is personal to the first user is associated with the first communication address.

8. The method of claim 7, wherein the first communication address is one of an email address, a telephone number, an instant messaging address, a short messaging system address, or a social network address.

9. The method of claim 8, wherein a private wall contains one of a one-way notification and a two-way interaction.

10. The method of claim 9, further comprising:
receiving first input from the first user in the personal information area of the first communication device, wherein the input is associated with the first communication address;
providing the first input to the virtual reality module;
providing the first input from the virtual reality module to the communication server.

11. A system, comprising:
a virtual reality server, including:
a communication interface;
memory;
a processor;
a virtual reality module stored in the memory and executed by the processor, wherein the virtual reality module is operable to register multiple users, provide shared information to the multiple registered users, provide information personal to the first user to the first user, and to provide information personal to the second user to the second user.

12. The system of claim 11, wherein the virtual reality module is further operable to generate a virtual reality user interface that is presented to the first user and to generate a virtual reality user interface that is presented to the second user, wherein the shared information is provided to the first user within a shared information area of the virtual reality user interface presented to the first user, wherein the information personal to the first user is provided to the first user within a personal information area of the virtual reality user interface presented to the first user, wherein the shared information is provided to the second user within a shared information area of the virtual reality user interface presented to the second user, and wherein the information personal to the second user is provided to the second user within a personal information area of the virtual reality user interface presented to the second user.

13. The system of claim 12, further comprising:
a communication network, wherein the virtual reality server is interconnected to the communication network;
a first communication device, wherein the first communication device is interconnected to the server by the communication network, the first communication device including:
a display, wherein the virtual reality user interface presented to the first user is presented by the display;
a second communication device, wherein the second communication device is interconnected to the server by the communication network, the second communication device including:
a display, wherein the virtual reality user interface presented to the second user is presented by the display.

14. The system of claim 13, further comprising:
a communication server, wherein the communication server is interconnected to the virtual reality server, wherein at least some of the information that is personal to the first user is provided to the virtual reality module by the communication server.

15. The system of claim 14, wherein the first communication device further includes:
a user input, wherein the user input is operable to enter user input in the personal information area of the virtual reality user interface presented to the first user, wherein the user input includes a communication addressed to the second communication device and to a third communication device, and wherein the communication is provided to the communication server by the virtual reality server.

16. The system of claim 15, further comprising:
a third communication device, wherein the communication is addressed to the third communication device and not to the second communication device, wherein the virtual reality module is further operable to generate a virtual reality user interface that is presented to a third user, wherein the third communication device is interconnected to the server by the communication network, the third communication device including:
a display, wherein the virtual reality user interface presented to the third user is presented by the display, wherein the shared information is displayed in a shared information area of the virtual reality user interface presented to the third user, wherein information personal to the third user is provided to the third user within a personal information area of the virtual reality user interface presented to the third user, wherein the information personal to the third user includes the communication addressed to the third communication device, and wherein the information personal to the second user does not include the communication addressed to the third communication device.

17. A computer readable medium having stored thereon computer executable instructions, the computer executable instructions causing a processor to execute a method for providing a virtual reality user interface, the computer executable instructions comprising:
instructions to provide shared information to a plurality of users participating in a virtual meeting;
instructions to provide first personal information to a first user participating in the virtual reality meeting, wherein the first personal information is only provided to the first user.

18. The computer readable medium of claim 17, the computer executable instructions further comprising:
instructions to receive first credential information from the first user and to register the first user in response to receiving the first credential information.

19. The computer readable medium of claim 18, the computer executable instructions further comprising:
instructions to obtain at least a first communication address related to the first user in response to receiving the first credential information, wherein the first personal information provided to the first user includes information addressed to the first communication address.

20. The computer readable medium of claim 19, the computer executable instructions further comprising:
instructions to receive second credential information from a second user and to register the second user in response to receiving the second credential information;
instructions to obtain at least a second communication address related to the second user in response to receiving the second credential information, wherein the second personal information provided to the second user includes information addressed to the second communication address.
